(19) United States
(12) Patent Application Publication
(10) Pub. No.: US 2010/0188951 A1
(43) Pub. Date: Jul. 29, 2010

(54) ENCODING DEVICE, SYSTEM AND METHOD

(76) Inventor: Eliezer Zeichner, Ramat Gan (IL)

Correspondence Address: The Law Office of Michael E. Kondoudis, 888 16th Street, N.W., Suite 800, Washington, DC, 20006, US

(21) Appl. No.: 12/668,452

(22) PCT Filed: Feb. 28, 2008
(86) PCT No.: PCT/IL08/00263

§ 371 Date: Jan. 11, 2010

Related U.S. Application Data
(60) Provisional application No. 60/935,343, filed on Aug. 8, 2007.

(51) Int. Cl. G11B 7/00

(52) U.S. Cl. 369/53.11; G9B/7

(57) ABSTRACT

The disclosure provides an encoding device comprising a reflector, a rotating disk having at least one aperture; and an optical unit comprising a light emitter and a light detector. Said disk being positioned between said reflector and said optical unit whereby rotation of said disk causes the movement of said at least one aperture in an alternating manner into a path of said light, such that said path is periodically interrupted and reestablished.

### CROSS REFERENCE TO RELATED APPLICATION

This application claims the benefit of U.S. Provisional Patent Application 60/935,343, filed Aug. 8, 2007, which is incorporated herein by reference.

### FIELD OF THE INVENTION

The present invention relates to the field of encoding devices. More specifically, the present invention relates to field of optical encoding devices.

### BACKGROUND OF THE INVENTION

Reference is made to FIG. A. In the art, encoding devices include those comprising a light emitter 202 that emits light towards a rotating element 200 in FIG. A that is shaped to enable periodic reflection of light from reflective segments (e.g. reflective segment 210 towards a light detector 201. However, such encoding devices may be subjected to various problems, including noise associated with the reflected light that is detected on the detecting element. Light incident on the rotating element may be affected by diffraction and/or scattering and/or deflection and/or other noise-generating phenomenon caused by the vibration of rotating element 200, which is schematically indicated with dashed and continuous lines thereof, thus causing a noisy pattern of light reflection as is schematically indicated with arrows S1 and S2. As a result, accuracy of the encoding device may be impaired significantly.

Reference is now made to FIG. B. In the art, apertures may be manufactured in a periodic manner on a rotating element 300, such that the light path between a light emitter 301 and detector 302 is intermittently shut in correspondence to the position of the apertures of rotating element 300. However, such apertured encoding devices require access from both sides of the encoder disk for light emission, detection and/or electrical connections to the light emitting or detection devices. This impairs the ease of automatic assembly, which has become essential for modern product competitiveness.

European Patent No. 0474149, the disclosure of which is incorporated herein by reference, describes an optical encoder that incorporates the deficiencies of both aforementioned encoding devices of the art. The optical encoder is used for detecting the position of a rotating object and includes a light source and a light detector that are located on opposing sides of the object thereby impairing the ease of automation. An array of lenses are located on the rotating object and light emitted along a light path from the light source is refracted through each lens onwards towards the light detector thereby exposing the light path at the lens to vibration that affects the accuracy of the optical encoder.

### SUMMARY

The following embodiments and aspects thereof are described and illustrated in conjunction with systems, tools and methods which are meant to be exemplary and illustrative, not limiting in scope.

In an embodiment, an encoding device comprises a rotating shaft coupled to a drive; a disk having at least one aperture; an optical unit, wherein said optical unit comprises a light emitter and a light detector; and a reflector; said reflector being substantially stationary coupled to said encoding device with regard to said optical unit such that light emitted from said light emitter is substantially reflected by said reflector to said detector; said disk being substantially fixedly coupled to said rotating shaft and being positioned between said reflector and said optical unit; whereby rotation of said disk causes the movement of said at least one aperture in an alternating manner into a path of said light, such that said path is periodically interrupted and reestablished.

In some embodiments the drive of said encoding device is located in a metal housing to thereby substantially shield components of the encoding device from electrical noise from the drive.

In some embodiments an encoding method is provided for encoding the movement of drives, said method comprising the steps of: detecting light pulses at a plurality of encoding devices; converting light pulses into electrical pulses; counting the number of electrical pulses received from each of said plurality of encoding devices; determining which of the plurality of encoding devices is associated with the highest count of electrical pulses; and temporarily altering the operation of the drive that is associated with the highest count of electrical pulses at a certain time.

In some embodiments each encoding device is provided with a processing unit, the processing unit being adapted to convert each light pulse of its encoding device into an electrical pulse.

In some embodiments a plurality of registers are provided, each register being associated with a given encoding device and the processing unit of the given encoding device being adapted to convert each electrical pulse of its encoding device into a value to be stored in the associated register.

In some embodiments a processor is provided, the processor being adapted to count the values stored in each register.

In some embodiments the processor is adapted to determine which encoding device is associated with the highest count.

In some embodiments the processor is adapted to determine a difference in values between two given registers.

In some embodiments if the difference is above a predetermined threshold the processor determines the operation of which drive to alter.

In some embodiments if the difference between a register associated with a drive previously altered and another register is below a predetermined threshold the processor causes the resumption of the operation of the drive.

In some embodiments the differences are determined periodically.

In some embodiments the operation of the drive is altered for a predetermined time-span.

In some embodiments if the values stored within all the registers are substantially identical and reached a predetermined threshold the values stored in the registers are reset to zero.

In some embodiments the operation of the drive is altered by stopping, slowing down or reversing the drive.

In addition to the exemplary aspects and embodiments described above, further aspects and embodiments will become apparent by reference to the figures and by study of the following detailed descriptions.

### BRIEF DESCRIPTION OF THE DRAWINGS

These and further features and advantages of the invention will become more clearly understood in the light of the ensuing description of a some embodiments thereof, given by way of example only, with reference to the accompanying figures (FIGs), wherein:

FIG. A is a schematic illustration of an encoding device, as known in the art;

FIG. B is a schematic illustration of another encoding device, as known in the art;

FIG. C is a schematic illustration of an encoding device, according to an embodiment of the invention;

FIG. 1 is a schematic detailed isometric assembly view of the encoding device, according to some embodiments of the invention;

FIG. 2 is a schematic detailed isometric illustration of the main elements of the encoding device, according to some embodiments of the invention;

FIG. 3 is a schematic detailed isometric exploded view of the encoding device, according to some embodiments of the invention;

FIG. 4 is a schematic detailed illustration of an encoding system, according to some embodiments of the invention; and

FIG. 5 is a flow-chart illustration of a method for performing synchronization between a plurality of encoding device, according to some embodiments of the invention.

The drawings taken with description make apparent to those skilled in the art how the invention may be embodied in practice.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate identical elements.

### DESCRIPTION OF SOME EMBODIMENTS OF THE INVENTION

Reference is now made to FIG. C. that improves on both known devices [Figs A and B] by combining both principles in such manner as to eliminate both known shortcomings. Since the suggested device uses a stationary reflector 410, which is positioned behind a rotating disk 400 having apertures. The stationary or substantially stationary behavior of reflector 410 results in an elimination or substantial elimination of noise which may otherwise be generated due to vibrations of reflective segments 210 in Fig. A. Vibration(s) of the apertured disk 400 has negligible effect on the generation of noise. Placing both light emitter 402 and light detector 401 on the same side of rotating disk 400 enables automatic assembly, thus reducing manufacturing time and improvement of quality encoding according to embodiments of the invention.

It should be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It should be understood that the phraseology and terminology employed herein is not to be construed as limiting and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other than the ones outlined in the description below.

It should be understood that the terms “including”, “comprising”, “consisting” and grammatical variants thereof do not preclude the addition of one or more components, features, steps, integers or groups thereof and that the terms are not to be construed as specifying components, features, steps or integers.

The phrase “consisting essentially of”, and grammatical variants thereof, when used herein is not to be construed as excluding additional components, steps, features, integers or groups thereof but rather that the additional features, integers, steps, components or groups thereof do not materially alter the basic and characteristics of the claimed composition, device or method.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein ought to be commonly understood as by one of ordinary skill in the art to which the invention belongs, unless otherwise defined.

The present invention can be implemented in the testing or practice with methods and materials equivalent or similar to those described herein.

The terms “right”, “left”, “bottom”, “below”, “low”, “top”, “above”, “elevated” and “high” as well as grammatical variations thereof as used herein do not necessarily indicate that, for example, a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

Although some demonstrative embodiments of the invention are not limited in this regard, discussions utilizing terms such as, for example, “processing,” “computing,” “calculating,” “determining,” “establishing”, “analyzing”, “checking”, “identifying” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to execute operations and/or processes and/or applications.

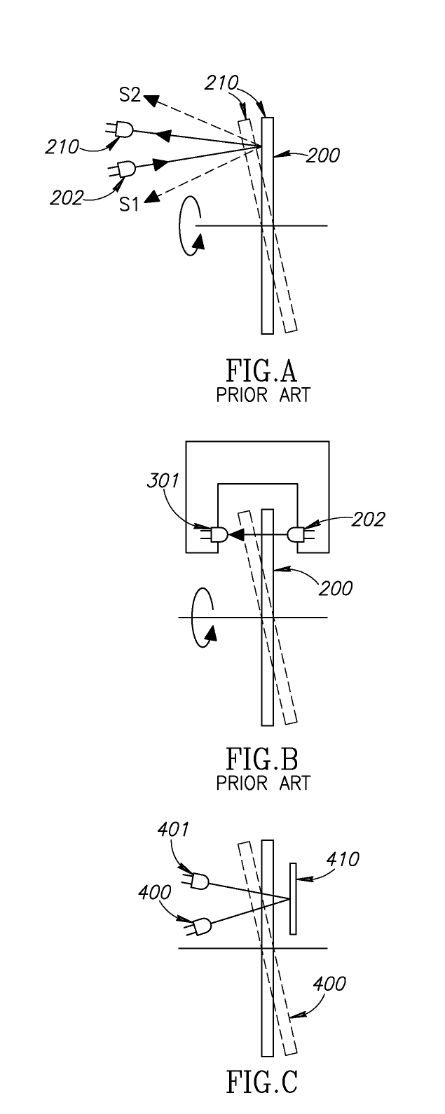

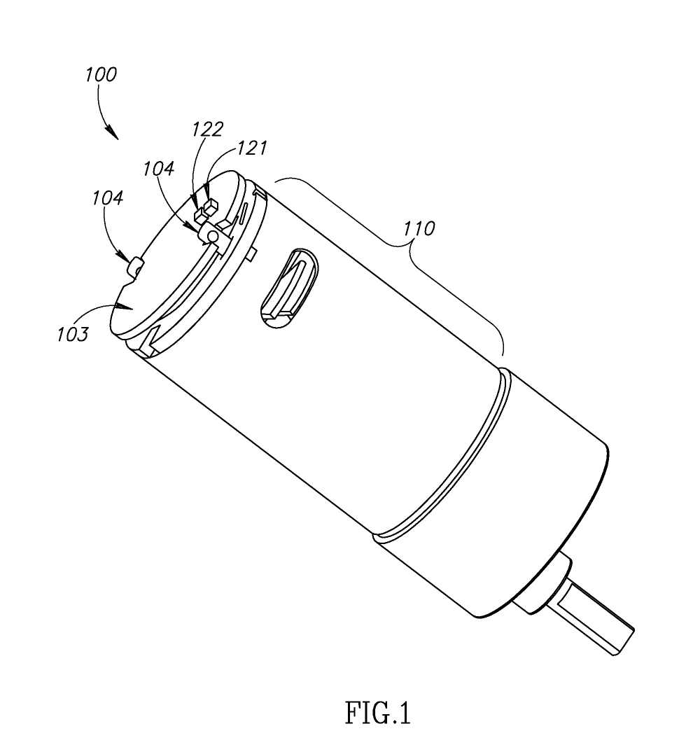

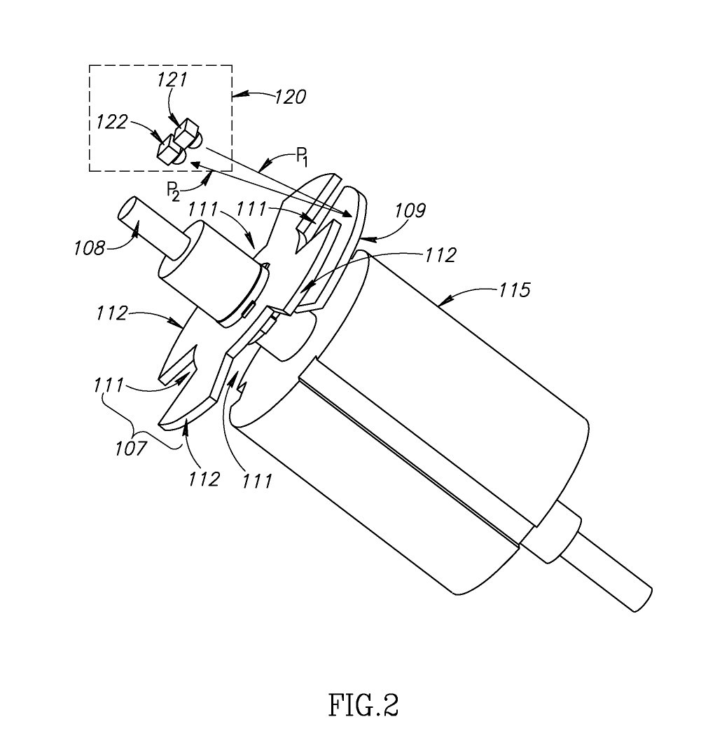

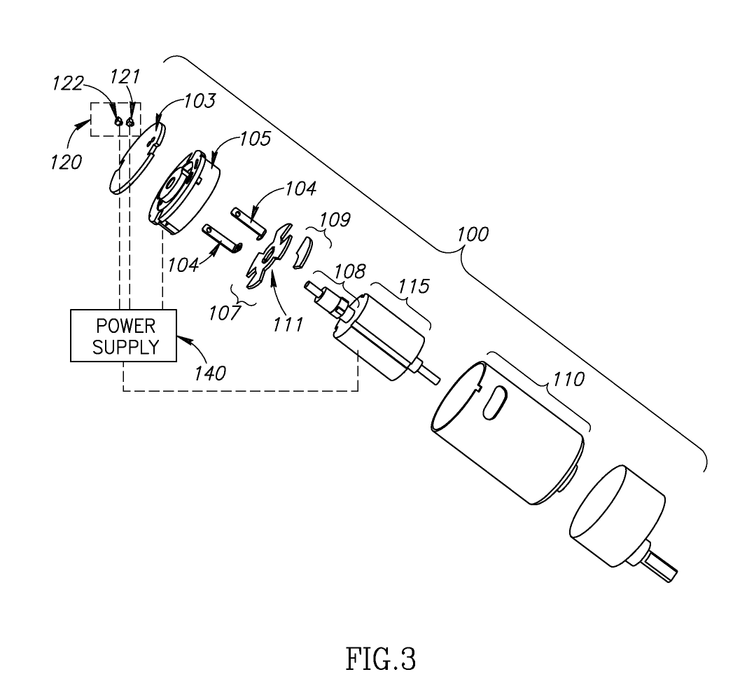

Reference is now made to FIG. 1, FIG. 2 and FIG. 3. According to some embodiments of the invention, an encoding device 100 includes a disk 107, which may have at least one aperture 111 and at least one wing 112. Disk 107 may be mechanically coupled to a rotating shaft 108 of a drive 115, which may be housed in a housing 110. Encoding device 100 may further include a reflector 109 that is stationary coupled relative to encoding device 100 with regard to an optical unit 120. Optical unit 120 may include a light emitter 121 and a light detector 122, both of which may be operatively linked to a processing unit 103. Light emitter 121 and light detector 122 may be mounted in front of rotating disk 107 such that rotating disk 107 is positioned between reflector 109 and optical unit 120. In some embodiments of the invention, light emitter 121 and light detector 122 may be embedded within processing unit 103 that may be mechanically coupled to, e.g., cover 105 by fastener elements such as, for example, contact leafs 104, whereby cover 105 may be positioned in front of rotating disk 107. Contact leafs 104 may provide support to processing unit 103 carrying some or all of the electronic elements required for operating encoding device 100. Correspondingly, optical unit 120, as well as other electronic components may be mounted in holes on processing unit 103 in alignment or in substantial alignment with holes in cover 105, thereby enabling the insertion of fasteners means such as, contact leafs 104 into the holes of processing unit 103 and cover 105 for fixedly aligning processing unit 103, cover 105, optical unit 120, and other elements on encoding device 100.

Thusly configured, two free light-paths looking at rotating disk 107 and at stationary reflector 109 are created. Cover 105, leafs 104, drive 115 and housing 110 may be standard parts of drive 115 itself, all of which may be available off-the-shelf. The few modification that may have to be made are the incorporation or manufacturing of holes into cover 105, thereby enabling light paths into and out of the motor; the use of contact leafs 104 which provide support to processing unit 103, which may abut to cover 105. Additionally, the disk 107 is fixedly mounted on motor rotor 115, and reflector 109 is fixedly mounted to motor housing 110.

Encoding device 100 may further include a power supply 140 that may be operatively linked to drive 115, light emitter 121, light detector 122 and to processing unit 103.

Light emitter 121, reflector 109 and light detector 122 are positioned relative to each other such that when aperture 111 is positioned in front of the optical axis of light emitter 121, light emitted from light emitter 121 may be substantially reflected by reflector 109 towards light detector 122. Correspondingly, light emitted from light emitter 121 may travel along a light path P1, via aperture 111 to reflector 109, which substantially reflects the light along light path P2 towards light detector 122. However, operating the drive 115 causes the rotation of disk 107, of which at least one wing 112 as a result thereof rotates as well and moves into and interrupts optical path P1 and/or optical path P2. As a result, light emitted from light emitter 121 may not be reflected to light detector 122. Continuation of rotation of disk 107 causes the at least one wing 112 to move away from optical path P1 and/or path P2 and the subsequent aperture 111 to move between optical path P1 and/or P2, thereby reestablishing optical path P1 and/or path P2 such that at least some light emitted from light emitter 121 travels substantially along optical path P1 and P2 towards light detector 122. In consequence, continuous rotation of disk 107 causes wing 112 and aperture 111 to move in an alternating manner into and out of optical path P1 and/or path P2, thereby causing substantially periodical interruption and reestablishment of optical path P1 and/or optical path P2. Thus, light may reach light detector 122 substantially periodically in a pulsed-like manner, whereby the period at which light is detected by light detector 122 depends on the rotational speed of disk 107 as well as on the spacing of aperture 111 and the number of apertures 111 of disk 107.

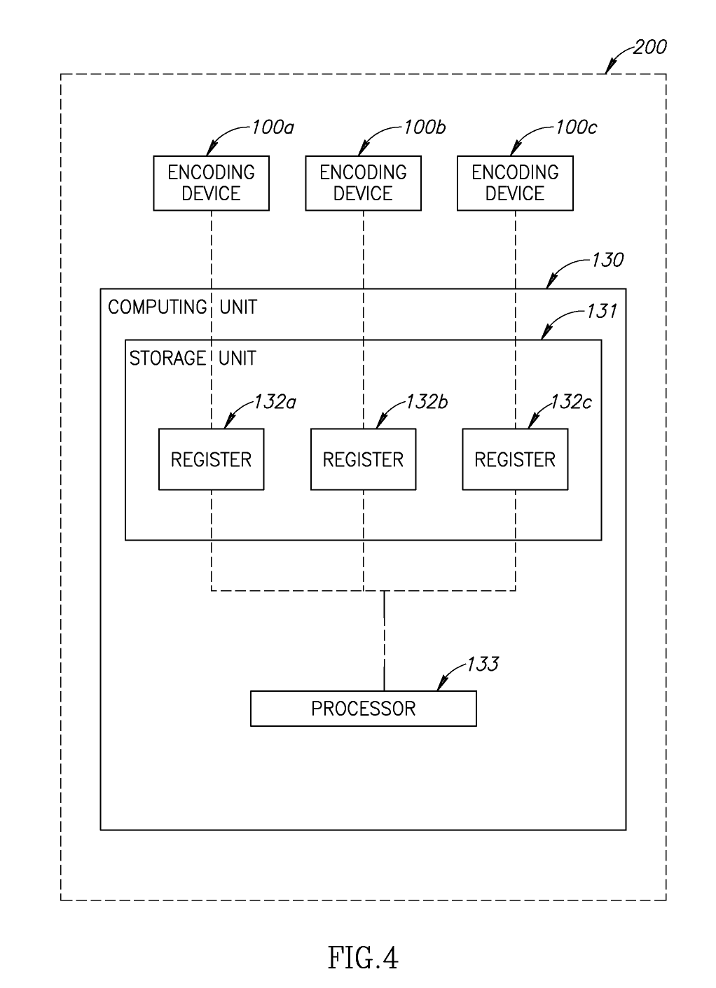

Additional reference is now made to FIG. 4. According to some embodiments of the invention, an encoding system 200 may include a plurality of encoding devices such as, for example, encoding devices 100a, 100b and 100c, each of which may be configured similarly or equally to encoding device 100 and each of which may be operatively linked to a computing unit 130 by wire and/or wirelessly. Computing unit 130 may include a plurality of registers such as register 132a, register 132b and register 132c, that are operatively linked to encoding devices 100a, 100b and 100c, respectively, in a manner that enables processing units 105 of respective encoding device 100a, 100b and 100c, to convert the light pulses received at light detector 122 into electronic pulses, which may then be converted into values that are sent to respective registers 132a, 132b and 132c, whereby the value stored in each register is updated in correspondence to the count of the number of light pulses detected by light detector 122.

It should be noted that the term “value” and grammatical variations thereof are hereinafter referred to as “count”.

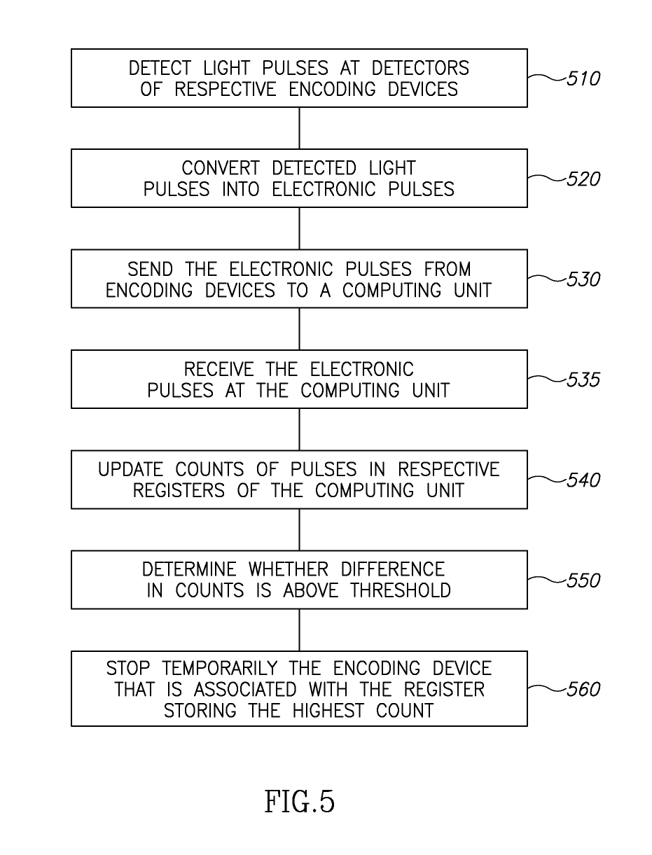

Registers 132a, 132b and 132 may be operatively linked to a processor 133 in manner that enables processor 133 to fetch counts from each register 132a, 132b and 132c. In addition, processor 133 is adapted to determine which register stores the highest count. This may be accomplished, for example, by comparing between fetched counts, and/or by using any other method, e.g., as known in the art. For example, processor 133 may compare a value stored in register 132a against a value compared stored in register 132b. Upon performing the comparison, processor 133 may operate respective drives 115 of encoding devices 100a, 100b and 100c accordingly, as outlined hereinafter with reference to FIG. 5.

In some embodiments of the invention, as indicated by box 510, a method for operating encoding system 200 may include, for example, the act of detecting light pulses at a plurality of detectors of respective encoding devices. For example, light pulses may be detected at light detectors 122 of respective encoding devices 100a, 100b and 100c.

In some embodiments of the invention, as indicated by box 520, the method for operating encoding system 200 may include, for example, the act of converting the detected light pulses into corresponding electronic pulses. Converting the detected light pulses into corresponding electronic pulses may be performed by a suitable sensor and electronic circuit at respective light detectors 122 and/or by respective processing units 105.

In some embodiments of the invention, as indicated by box 530, the method may include, for example, the act of sending the electronic pulses from encoding devices to a computing unit such as, for example, computing unit 130. For example, electronic pulses may be sent from encoding devices 100a, 100b and 100c to computing unit 130. The electronic pulses may be sent to a computing unit, via a wireless communication link and/or via a wire communication link.

In some embodiments of the invention, as indicated by box 535, the method may include, for example, the act of receiving the electronic pulses at the computing unit which may be, for example, computing unit 130.

In some embodiments of the invention, as indicated by box 540, the method may include, for example, the act of updating counts in registers of the computing unit in correspondence to the number of electronic pulses received from each encoding device. For example, processor 133 may update counts in register 132a, 132b and 132c in accordance to the number of electrical pulses received from encoding devices 100a, 100b and 100c, respectively, at computing unit 130.

As indicated by box 550, the method may include, for example, the act of determining whether the difference in counts between two registers is above a predetermined threshold. For example, processor 133 may subtract the count stored in register 132a from the count stored in register 132b and determine whether the resulting difference is below a predetermined threshold or not. In the event that the resulting difference is above a predetermined threshold, processor 133 may determine which register stores therein the higher count.

In some embodiments of the invention, processor 133 may periodically or substantially periodically determine the difference of counts of a first register against counts of a second register.

As indicated by box 560, the method may include, for example, the act of temporarily stopping the operation of the encoding device that is associated with the register that stores therein at the specific time the highest count. For example, in the event that a difference in counts is above the predetermined threshold, processor 133 may cause the stopping of the operation of the drive with the encoding device that is associated with the register storing therein the highest count. However, in the event that a difference in counts is below the predetermined threshold, processor 133 may cause the resumption of the operation of the drive of the encoding device that was previously stopped. In some embodiments of the invention, the drive that is associated to the register comprising the highest count may not be stopped completely but may only slowed down. For example, if the count in register 132a is higher than the count in register 132b and the difference in counts stored in register 132a and 132b is above a predetermined threshold, then the drive of encoding device 100a may be slowed down during a predetermined time or until the difference in counts stored in registers 132a and 132b is below the predetermined threshold.

For example, if processor 133 determines that register 132b stores therein at a specific time the highest count, then processor 133 may send a signal representing a command to temporarily stop the operation of drive 115 of the respective encoding device 100b. The time-span during which the operation of an encoding device is stopped, may be predetermined in processor 133. Optionally, a user of encoding system 200 may determine the time span during which the operation of the corresponding encoding device is to be stopped. The predetermined time-span may be, for example, 0.5, 0.8, 1 or 1.5 seconds.

According to some embodiments of the invention, the act of determining which register stores the highest count (box 550) may be performed periodically. For example, processor 133 may determine every 1.4, 2, 2.5, or 2.8 seconds, which register stores therein the highest counts. If there is such an exceed in the predetermined threshold, processor 133 may issue a signal carrying data representing a command to stop the drive that is associated to the register having the higher or the highest count. In some embodiments of the invention, the drive of the encoding device, which is associated to the register having stored therein the highest count at a certain time, may be temporarily stopped.

It should further be noted that various operations may be performed in the event that the difference equals the threshold. For example, in one embodiment of the invention, in the event that the difference in counts between two registers equals the threshold, processor 133 may not cause a change in the operation of the drive with the encoding device that is operatively linked to the register which stores therein the higher count. In some other embodiments of the invention, processor 133 may reverse the operational status of the drive associated with the encoding device that is linked to the register storing therein the higher count. For example, the operation of a stopped encoding device that is operatively linked to the register storing the higher count, may be resumed. In some alternative embodiments of the invention, a drive with the encoding device that is in operation may be stopped, if said encoding device is operatively linked to the register storing therein the higher count.

As outlined above, the encoding device may be operatively linked to encoding devices 100a and 100c may substantially catch up to the position of the apparatus that is operatively linked to encoding device 100b.

In some embodiments of the invention, counts stored in a plurality of registers may be reset and/or set to zero when, for example, a count reaches or is above a certain threshold. However, the resetting may in this case only be performed in the event that the respective encoding devices are synchronized. Additionally or alternatively, counts stored in plurality of registers may be reset and/or zeroed in the event that respective encoding devices reach a corresponding sensor which may be, for example, a limit switch.

It should be noted that since light emitter 121 and light detector 122 are mounted on the same side, encoding device 100 may be assembled in a fully automatic and single-sided manner. Furthermore, since reflector 109 is positioned substantially stationary with regard to optical unit 120, noise and tremor may be significantly reduced.

A processor such as, for example, processor 133 and processing unit 105 may be embodied, without limitations, by a chip, by a microprocessor, by a controller, by a Central Processing Unit (CPU), by a Digital Signal Processor (DSP), by a microchip, by an Integrated Circuit (IC), or any other suitable multi-purpose or specific processor or controller or electronic circuit.

A storage unit such as, for example, storage unit 131 may be embodied, without limitations, by a hard disk drive, or other suitable removable or non-removable storage units. Furthermore, storage unit 131 may be embodied, for example, by a Random Access Memory (RAM), by a Dynamic RAM (DRAM), by a Synchronous DRAM (SD-RAM), by a Flash memory, by a volatile memory, by a non-volatile memory, by a cache memory, by a buffer, by a short-term memory unit, by a long-term memory unit, or other suitable memory units or storage units.

A power supply may be embodied, without limitations, by a rechargeable battery, by a non-rechargeable battery, or by any other suitable power supply.

It should be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine may include, for example, any suitable processing platform, computing platform, computing device, processing device, computing system, processing system, computer, processor, or the like, and may be implemented using any suitable combination of hardware or software or both. The machine-readable medium or article may include but is not limited to, any suitable type of memory unit, memory device, memory article, memory medium, storage article, storage device, storage medium or storage unit such as, for example, memory, removable or non-removable media, erasable or non-erasable media, writeable or re-writeable media, digital or analog media, optical disk and a hard disk. The instructions may include any suitable type of code, for example, an executable code, a compiled code, a dynamic code, a static code, interpreted code, a source code or the like, and may be implemented using any suitable high-level, low-level, object-oriented, visual, compiled or interpreted programming language. Such a compiled and/or interpreted programming language and/or programming environment may be, for example, C, C++, C#, .Net, Java, Pascal, MATLAB, BASIC, Cobol, Fortran, assembly language, machine code and the like.

It should be noted that embodiments of the invention may be used in a variety of applications. Examples of embodiments of the invention may include the usage of the invention in conjunction with many networks. Examples of such networks may include, without limitation, a wide area network (WAN), local area network (LAN), a global communication network, e.g., the Internet, a wireless communication network such as, for example, a wireless LAN (WLAN) communication network, a wireless virtual private network (VPN), a Bluetooth or ZIG-BEE or similar network, a cellular communication network, for example, a 3^{rd} Generation Partnership Project (3GPP), such as, for example, a Global System for Mobile communications (GSM) network, a Code Division Multiple Access (CDMA) communication network, a Wideband CDMA communication network, a Frequency Domain Duplexing (FDD) network, and the like. Therefore, a plurality of encoding devices may be synchronized over large distances, thus enabling to control and/or synchronize and/or manipulate complex manual and/or automatic and/or semiautomatic tasks such as, for example, surgeries taking place in two different countries.

The system, device and method of the present invention may have various advantages over encoding systems, devices and methods known in the art. For example, encoding devices, systems and methods use tachometers or potentiometers, both of which are prone to measuring errors. More specifically, a tachometer based encoding device, system and method may comprise an integrating module (e.g., implemented by an integrating circuit) which integrates generated pulses over time on a capacitor, whereby the integrated pulses are represented by means of voltage that has to be processed by an analog to digital conversion (A/D) module, in order to enable digital processing of the voltage. Providing an integrating circuit as well as an A/D module renders the device and system more expensive. Moreover, an A/D module as well as an integrating module is prone to physical influences such as changes in temperature, pressure, humidity and the like, thus making the device and system prone to inaccuracies.

Potentiometers are resistance-based electro-mechanical elements. However, resistances are easily influenced by changes in their physical environment such as, for example, temperature, humidity, pressure and the like. As a consequence, potentiometers are prone to produce measurement errors.

It should further be noted that components of driver 115 such as, for example, commutator and brushes, may generate electrical noise and are housed within driver's 115. However, cover 105 may be made of metal and said components may be housed within the housing of driver 115, whereas optical unit 120, processing unit 103 (and its optionally included electronic circuits) is located outside driver 115. Thusly configured, processing unit 103 may be shielded or substantially shielded from electrical noise generated by drive 115. Therefore, an encoding device according to an embodiment of the invention such as, for example, encoding device 100, may be much less susceptible to error-causing interference and/or noise.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims and their legal equivalents. Therefore, it should be understood that alternatives, modifications, and variations of the present invention are to be construed as being within the scope of the appended claims.

What is claimed is:

1. An encoding device for encoding the movement of drives, said device comprising:
a rotating shaft coupled to a drive;
a disk comprising at least one aperture;
an optical unit comprising a light emitter and a light detector; and
a reflector;
said reflector being substantially stationary with regard to said optical unit such that light emitted from said light emitter is substantially reflected by said reflector to said detector;
said disk being substantially fixedly coupled to said rotating shaft, wherein
said disk being positioned between said reflector and said optical unit whereby rotation of said disk causes the movement of said at least one aperture in an alternating manner into a path of said light, such that said path is periodically interrupted and reestablished.

2. An encoding method for encoding the movement of drives, said method comprising the steps of:
detecting light pulses at a plurality of encoding devices;
converting light pulses into electrical pulses;
counting the number of electrical pulses received from each of said plurality of encoding devices;
determining which of the plurality of encoding devices is associated with the highest count of electrical pulses; and
temporarily altering the operation of the drive that is associated with the highest count of electrical pulses at a certain time.

3. The encoding method of claim 2, wherein each encoding device is provided with a processing unit, the processing unit being adapted to convert each light pulse of its encoding device into an electrical pulse.

4. The encoding method of claim 3, wherein a plurality of registers are provided, each register being associated with a given encoding device and the processing unit of the given encoding device being adapted to convert each electrical pulse of its encoding device into a value to be stored in the associated register.

5. The encoding method of claim 4, wherein a processor is provided, the processor being adapted to count the values stored in each register

6. The encoding method of claim 5, wherein the processor is adapted to determine which encoding device is associated with the highest count.

7. The encoding method of claim 5, wherein the processor is adapted to determine a difference in values between two given registers.

8. The encoding method of claim 7, wherein if the difference is above a predetermined threshold the processor determines the operation of which drive to alter.

9. The encoding method of claim 8, wherein if the difference between a register associated with a drive previously altered and another register is below a predetermined threshold the processor causes the resumption of the operation of the drive.

10. The encoding method of claim 7, wherein the differences are determined periodically.

11. The encoding method of claim 8, wherein the operation of the drive is altered for a predetermined time-span.

12. The encoding method of claim 4, wherein if the values stored within all the registers are substantially identical and reached a predetermined threshold the values stored in the registers are reset to zero.

13. The encoding method of claim 2, wherein the operation of the drive is altered by stopping, slowing down or reversing the drive.

14. The encoding device of claim 1, wherein the drive is located in a metal housing to thereby substantially shield components of the encoding device from electrical noise from the drive.
